(19) United States
(12) Patent Application Publication
(10) Pub. No.: US 2003/0000337 A1
(43) Pub. Date: Jan. 2, 2003

(54) Apparatus and method for controlling fluid flow in gear assembly of vehicle

(76) Inventor: Paul C. Camping, Phoenix, AZ (US)

Correspondence Address: TOD R. NISSLE, P.C., P.O. Box 55630, Phoenix, AZ, 85078, US

(21) Appl. No.: 09/896,816

(22) Filed: Jun. 29, 2001

(51) Int. Cl. F16H 47/00

(52) U.S. Cl. 74/655

(57) ABSTRACT

Apparatus is provided for controlling the flow of lubricant in a gear assembly, for filtering lubricant in gear assembly, and for lubricating designated portion of the gear assembly. The apparatus deflects lubricant is a desired direction of travel and administers lubricant to selected operational surfaces in the gear assembly.

This invention relates to apparatus and methods for controlling the flow of lubricants in a gear assembly.

In another respect, the invention relates to apparatus and methods for filtering lubricants in a gear assembly.

In a further respect, the invention relates to apparatus and methods for lubricating designated portions of a gear assembly.

The transmission and differential gear assembly of a vehicle typically include a plurality of lubricated gears. The differential gear assembly is an arrangement of gears forming an epicyclic train for connecting two shafts or axles in the same line, dividing the driving force equally between them, and permitting one shaft to revolve faster than the other when desired (as by the driving wheels of an automobile that is moving along a curved path of travel), the speed of the main driving member always being equal to the algebraic mean of the speeds of the two shafts.

One problem associated with conventional gear assemblies is the tendency of a particular bearing assembly or other portion of the gear assembly to be inadequately lubricated, resulting in the premature failure of that portion of the gear assembly.

Accordingly, it would be highly desirable to provide an improved method and apparatus for lubricating a gear assembly to reduce the risk of premature failure of a particular portion of the gear assembly.

Therefore, it is a principal object of the invention to provide an improved gear assembly.

Another object of the invention is to provide an improved gear assembly which improves the lubrication of a particular portion of the gear assembly.

These and other, further and more specific objects and advantages of the invention will be apparent to those skilled in the art from the following detailed description thereof, taken in conjunction with the drawings, in which:

FIG. 1 is a perspective view illustrating a portion of the housing of a conventional differential gear assembly for rear wheel drive vehicles;

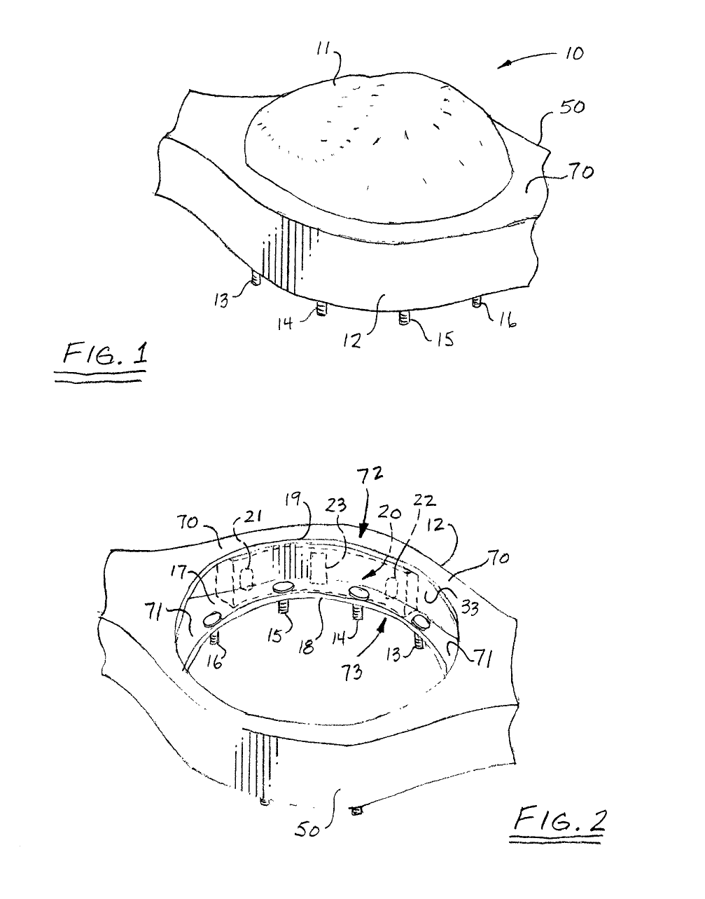

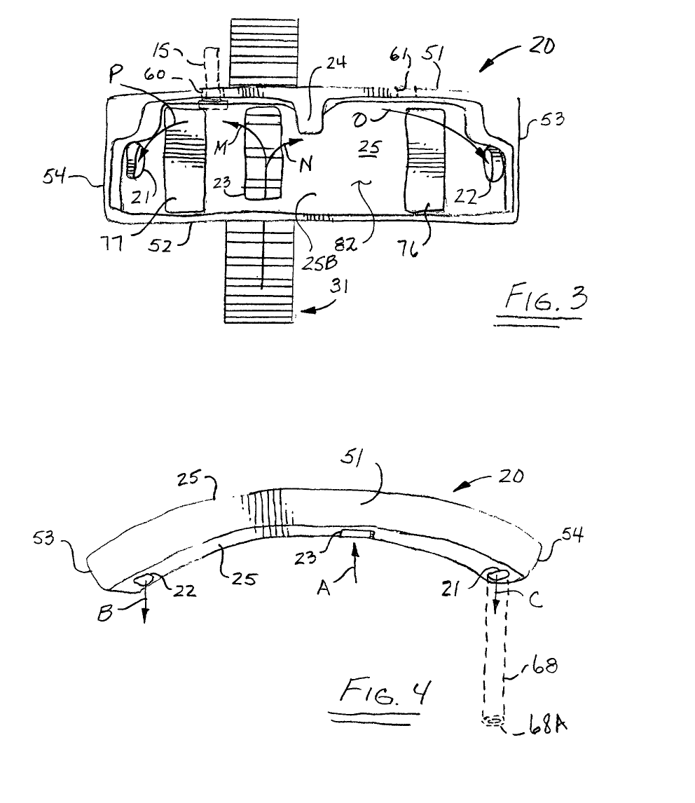

FIG. 2 is a perspective view illustrating the apparatus of FIG. 1 with the rear cover removed;

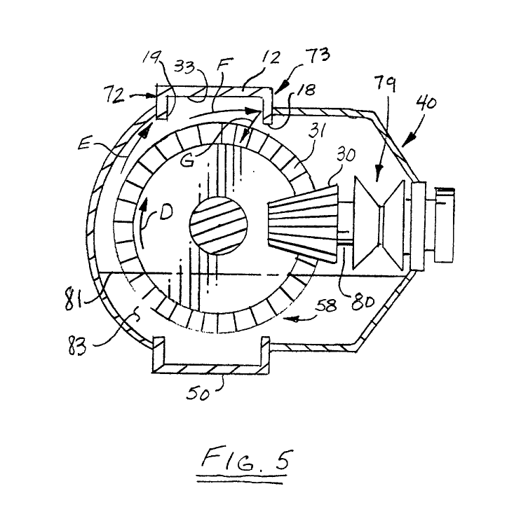

FIG. 3 is a top view illustrating fluid control apparatus constructed in accordance with the principles of the invention and further illustrating the mode of operation thereof;

FIG. 4 is a front view of the apparatus of FIG. 3 illustrating further construction details thereof;

FIG. 5 is a sectional view illustrating the housing and rear cover of FIG. 1, and further including the front cover and portions of the differential gear unit housed therein;

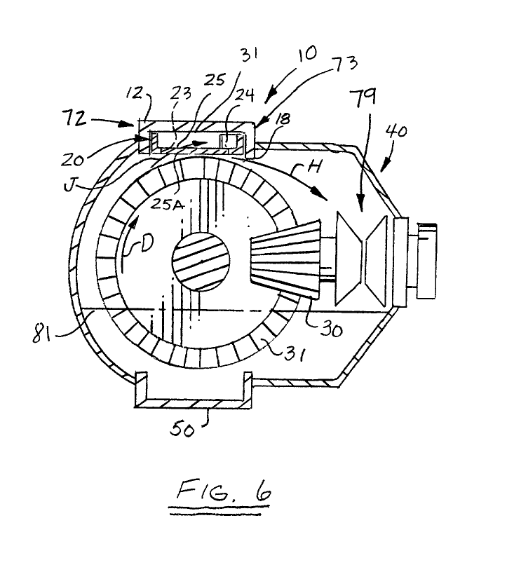

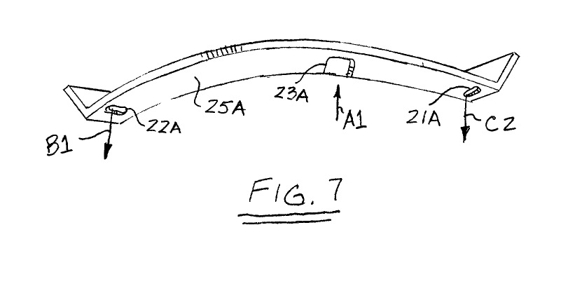

FIG. 6 is a sectional view of the housing and rear cover of FIG. 5 illustrating the fluid control apparatus of the invention mounted therein; and, FIG. 7 is a front perspective view of an alternate embodiment of the fluid control apparatus of the invention.

Briefly, in accordance with the invention, I provide improvements for a differential gear assembly. The gear assembly includes a housing including at least one inwardly extending flange on the inside of the housing; a reservoir of lubricating fluid in the housing; and, a plurality of gears mounted in the housing. A portion of at least one of the gears extends into the reservoir of fluid when the differential gear assembly is at rest. The housing and gears are shaped and dimensioned such that during operation of the differential gear assembly, the gear extending into the reservoir turns and throws fluid from the reservoir against the flange. The improvements comprise a fluid control member for at least partially preventing fluid thrown by the gear extending into the reservoir from contacting flange. The fluid control member comprises a control member mounted inside the housing adjacent the flange. The control member covers at least a portion of the flange such that a greater portion of the lubricating fluid thrown toward the flange by the gear contacts the control member and flows past the flange.

In another embodiment of the invention, I provide improvements for a gear assembly. The gear assembly includes a housing; a reservoir of lubricating fluid in the housing; and, a plurality of gears mounted in the housing. A portion of at least one of the gears extends into the reservoir of fluid when the differential gear assembly is at rest. The gear assembly also includes an operational surface which requires lubrication. The housing and gears are shaped and dimensioned such that during operation of the gear assembly, the gear extending into the reservoir turns and displaces fluid out of the reservoir. The improvements comprise a fluid control member mounted on the housing for collecting lubricating fluid displaced out of the reservoir by the gear extending into the reservoir; and, for directing lubricating fluid against the operational surface.

In a further embodiment of the invention, I provide improvements for a gear assembly. The gear assembly includes a housing, a reservoir of lubricating fluid in the housing, and, a plurality of gears mounted in the housing. A portion of at least one of the gears extends into the reservoir of fluid when the differential gear assembly is at rest. The gear assembly also includes an operational surface which requires lubrication. The housing and gears are shaped and dimensioned such that during operation of the gear assembly, the gear extending into the reservoir turns and displaces fluid out of the reservoir. The improvements comprise a fluid control member mounted inside the housing for collecting lubricating fluid displaced out of the reservoir by the gear extending into the reservoir; and, for filtering the lubricating fluid.

In still another embodiment of the invention, I provide an improved method for controlling the flow of lubricant in a gear assembly. The gear assembly includes a housing including at least one inwardly extending flange on the inside of the housing, includes a reservoir of lubricating fluid in the housing, and includes a plurality of gears mounted in the housing. A portion of at least one of the gears extends into the reservoir of fluid when the differential gear assembly is at rest. The housing and gears are shaped and dimensioned such that during operation of the differential gear assembly, the gear extending into the reservoir turns and displaces fluid from the reservoir against the flange. The improved method includes the steps of providing a control member shaped and dimensioned such that when the control member is mounted inside the housing, fluid displaced against the control member is deflected to a selected direction of travel. The improved method also includes the steps of installing the control member inside the housing adjacent the flange; and, operating the differential gear assembly.

Turning now to the drawings, which illustrate the presently preferred embodiments of the invention for the purpose of illustrating the practice thereof, and not by way of limitation of the scope of the invention, and in which like reference characters refer to like element throughout the several views, FIG. 1 illustrates a portion of a conventional stamped differential housing 10 for rear wheel drive vehicles. The housing 10 includes arcuate rear cover 11, side 12, and side 50. Side 50 opposes and is spaced apart from side 12. When housing 10 is installed on a vehicle, cover 11 faces the back or rear of the vehicle, side 12 is on top, and side 50 is on the bottom facing the ground. In FIG. 1, the front cover (not shown) of housing 10 is attached using the externally threaded ends of bolts 13 to 16 and other bolts (not visible) which extend outwardly from housing 10.

In FIG. 2, rear cover 11 is removed to reveal additional internal construction details of housing 10. An arcuate aperture is formed through upper wall 70 and is circumscribed by peripheral edge 19. Another arcuate aperture is formed through lower wall 71 and is circumscribed by arcuate peripheral edge 18. The portions of wall 70 adjacent edges 18 and 19 are substantially parallel to the portions of wall 71 adjacent edges 18 and 19. As can be seen in FIG. 2, a portion of upper wall 70 forms a first flange 72 which is connected to and extends outwardly from side 12. Flange 72 includes a portion of edge 19. Similarly, a portion of lower wall 71 forms a second flange 73 which is connected to and extends outwardly from side 12. Flange 73 includes a portion of edge 18. Flange 72 is substantially parallel to flange 73. As will be discussed with reference to FIG. 5, flanges 72 and 73 interfere with the circular flow or path of travel of lubricant that is caused by and associated with the rotation of ring gear 31. As will be further discussed with reference to FIG. 6, in the practice of one embodiment of the invention, a flow control member, indicated by dashed lines 20 in FIG. 2, is inserted between and adjacent flanges 72 and 73 and adjacent the inner arcuate surface 33 of side 12. The flow control member 20 reduces the interference of flanges 72 and 73 with the circular flow of lubricant produced by the rotation of ring gear 31. When gear turns it displaces liquid lubricant out of reservoir 83 along a generally circular path of travel.

To install member 20, bolts 14 and 15 in FIG. 2 are removed from flange 73, member 20 is installed in the position shown in FIG. 2, and the ends of bolts 14 and 15 are inserted through the apertures 60 and 61 (FIG. 3) formed in the side of member 20 and through the pre-existing apertures in flange 73 which are each aligned with one of apertures 60 and 61. When member 20 is installed in the position shown in FIG. 2, apertures 60 and 61 align and are in registration with existing apertures in flange 73 so that each bolt 14 and 15 can be inserted through one of apertures 60 and 61 and through one of the apertures in flange 73 which is in registration with apertures 60 and 61. As would be appreciated by those of skill in the art, member 20 can, instead of being secured with bolts, be welded, glued, or otherwise secured in the position illustrated in FIG. 2 and FIG. 6.

Member 20 is depicted in FIGS. 3 and 4. Member 20 is arcuate and is shaped and dimensioned to conform to and fit against surface 33 and between flanges 72 and 73 in the manner illustrated in FIG. 2. Interconnected walls 51 to 54 outwardly depend from base 25. Rectangular aperture 23 is formed through base 25, as are apertures 21 and 22. A tube 68 can be affixed to aperture 21 such that lubricant flowing through aperture 21 flows into the tube 68 and flows out the end 68A of tube 68. Tube 68 is shaped and dimensioned such that lubricant flows out of end 68A at a desired location in a gear assembly; for instance, flows out of tube 68 and onto a bearing or other operational surface which requires lubrication. Aperture 22 can also be provided with a tube which receive lubricant flowing out of aperture 22 and carries the lubricant to a desired location in a gear assembly.

As illustrated in FIG. 3, when ring gear 31 is rotating during operation of the differential assembly (and during the simultaneous operation of the vehicle engine or other prime mover which turns the gear 58 and other parts of the differential assembly), gear 31 displaces oil or other lubricant from reservoir 83 into member 20 in the directions indicated by arrows M and N. The lubricant flows intermediate base 25 and inner surface 33 to apertures 21 and 22 in the manner indicated by arrows P and O, respectively. The lubricant then exits through aperture 21 in the direction indicated by arrow C (FIG. 4) and through aperture 22 in the direction indicated by arrow B (FIG. 4).

Apertures 23, 21, 22 are sized such that during operation of the differential assembly, the space 82 between base 25 and surface 33 fills up with lubricant and the continued delivery by ring gear 31 of lubricant to aperture 23 creates pressure in the inner space 82 bounded by member 20 and surface 33 because lubricant can not exit through apertures 21 and 22 as quickly as the lubricant is being delivered through aperture 23. This pressurization of the lubricant in member 20, and the resultant slow down of lubricant flowing into aperture 23 in the direction of arrows M and N, facilitates the travel of lubricant against and past the outer surface 25A of base 25 in the direction indicated by arrow H in FIG. 6. Surface 25A deflects some lubricant in the direction indicated by arrow H.

As shown in FIG. 3, magnets 76, 77 can be mounted on inner surface 25B of base 25 to remove iron particles from lubricant flowing through member 20. The shape and dimension of magnets 76, 77 can vary as desired, as can the placement and number of magnets in member 20. Other kinds of filter units can be utilized in conjunction with or in place of magnets 76, 77.

In FIG. 5, a conventional differential gear assembly includes ring gear 31. Gear 31 is turned by pinion gear 30. The pinion assembly 79 includes a pair of pinion bearings each mounted in its own pinion cup. One end of shaft 80 is attached to pinion gear 30. The other end of shaft 80 (not shown) is attached to a yolk (not shown). A U-joint interconnects the yolk and the drive shaft. The ring gear is bolted to a carrier (not shown). The carrier is a housing which includes pinion gears and other gears. There are carrier bearings on either side of the carrier. One end of left rear axle (not shown) is connected to the left wheel hub. The other end of the left rear axle extends into housing 10 and into the carrier and engages gears in the carrier which turn the left rear axle. One end of the right rear axle (not shown) is connected to the right wheel hub. The other end of the right rear axle extends into housing 10 and into the carrier and engages gears in the carrier which turn the right rear axle.

As can be seen in FIG. 5, flanges 72 and 73 in a conventional stamped differential gear assembly interfere with the circular flow or displacement of lubricant produced when ring gear 33 is turned in the direction indicated by arrow D. The desired circular flow of lubricant is interrupted when lubricant travels in the direction indicated by arrow E and contacts flange 72, and, travels in the direction indicated by arrow F and contacts and rebounds from flange 73 in the direction indicated by arrow G. The interruption in the flow of lubricant caused by flanges 72 and 73 can prevent bearings in the pinion assembly 79 from being properly lubricated. The flow control member 20 of the invention solves this problem by filling the space between flanges 72 and 73 which exists above ring gear 31. Once this space is filled, a proportion of lubricant travels into member 20 via aperture 73 in the manner earlier described and indicated by arrow J in FIG. 6. However, the remaining outer surface area 25A of base 25, along with the resistance to lubricant flow through aperture 73 which results when fluid in member 20 is pressurized, causes the larger proportion of lubricant to travel over the outer surface of base 25 and past flanges 72, 73 in the manner indicated by arrow H to reach and lubricate the bearing in the pinion assembly 79.

While the ring gear 31 is rotating in the direction of arrow D, lubricant which travels up through aperture 73 in the manner indicated by arrow J then travels transverse to the vertically oriented plane in which gear 31 rotates and exits through apertures 21 and 22. If desired, apertures 21 and 22 are positioned over carrier bearings, or tubes 68 attached to apertures 21 and 22 direct lubricant to carrier bearings or to any other operational surface in the differential bearing assembly which requires lubrication.

In FIGS. 5 and 6, line 81 indicates level of oil or other lubricant in the reservoir 83 in the differential gear assembly when ring gear 31 is at rest and is not moving. Once the motor of the vehicle is started and the vehicle begins to move forward (or backward), the differential gear 31 begins to operate (rotate) and displaces and carries lubricant upwardly out of the lubricant along a generally circular path of travel.

As would be appreciated by those of skill in the art, the transmission of a vehicle along includes a plurality of gears and a lubricating fluid. The flow control member of the invention can be utilized in a transmission to filter transmission fluid, to direct transmission fluid to desired lubrication points, and to improve the fluid flow in a transmission.

Member 20 can be shaped and dimensioned to improve lubricant flow in a gear assembly by directing lubricant flow in any desired direction or manner, regardless of whether flanges 72, 73 are present.

Member 20 can be produced in a variety of shapes and dimensions as long as the desired function or functions of the invention are served. For example, in FIG. 7 a fluid control member is formed by bending a strip of metal into the arcuate U-shape shown. The size, position of and spacing between apertures 23A, 22A, and 21A in FIG. 7 corresponds to that of apertures 23, 22, and 21, respectively, in FIG. 4. The size and position of each aperture 23, 22, 21 can vary as desired. Only one of apertures 21 and 22 may be utilized, or lubricant return apertures can be utilized in addition to or in place of apertures 21 and 22.

In FIG. 6, when member 20 is installed inside housing 10, the outer surface 25A of base 25 is substantially flush, or even, with edges 18 and 19. While this is desired in the practice of the invention, it is not required. If member 20 is shaped and dimensioned such surface 25A of that base 25 is inset from edges 18 and 19 toward surface 33, this permits some of the lubricant to contact flange 73. Even if this occurs, member 20 still facilitates the flow of lubricant toward the bearings in pinion assembly 79 because member 20 will cover at least a portion of the surfaces of flange 73 and 72 which were exposed prior to the insertion of member 20.

Having described the invention in such terms as to enable those of skilled in the art to understand and practice the invention, and having described the presently preferred embodiments thereof, I claim:

1. In combination with a differential gear assembly, the gear assembly including
a housing including at least one inwardly extending flange on the inside of the housing,
a reservoir of lubricating fluid in the housing, and
a plurality of gears mounted in the housing, a portion of at least one of the gears extending into the reservoir of fluid when the differential gear assembly is at rest,
the housing and gears being shaped and dimensioned such that during operation of the differential gear assembly, the gear extending into the reservoir turns and throws fluid from the reservoir toward and against the flange,
the improvements comprising fluid control means for at least partially preventing lubricating fluid thrown by the gear from contacting the flange, the fluid control means comprising a control member mounted inside the housing adjacent the flange, the control member covering at least a portion of the flange such that a portion of the lubricating fluid thrown toward the flange by the gear that extends into the reservoir of fluid contacts the control member and flows past the flange.

2. In combination with a differential gear assembly, the gear assembly including
a housing,
a reservoir of lubricating fluid in the housing,
a plurality of gears mounted in the housing, a portion of at least one of the gears extending into the reservoir of fluid when the differential gear assembly is at rest, and
an operational surface requiring lubrication,
the housing and gears being shaped and dimensioned such that during operation of the gear assembly, the gear extending into the reservoir turns and displaces fluid out of the reservoir,
the improvement comprising fluid control means mounted on the housing for
(a) collecting lubricating fluid displaced out of the reservoir by the gear extending into the reservoir; and,
(b) directing lubricating fluid against the operational surface.

3. In combination with a differential gear assembly, the gear assembly including
a housing,
a reservoir of lubricating fluid in the housing,
a plurality of gears mounted in the housing, a portion of at least one of the gears extending into the reservoir of fluid when the gear assembly is at rest, and
an operational surface requiring lubrication,
the housing and gears being shaped and dimensioned such that during operation of the gear assembly, the gear extending into the reservoir turns and displaces fluid out of the reservoir,
the improvement comprising fluid control means mounted inside the housing for
(a) collecting lubricating fluid displaced out of the reservoir by the gear extending into the reservoir; and,
(b) filtering the lubricating fluid.

4. A method for controlling the flow of lubricant in a gear assembly, the gear assembly including
a housing,
a reservoir of lubricating fluid in the housing, and
a plurality of gears mounted in the housing, a portion of at least one of the gears extending into the reservoir of fluid when the differential gear assembly is at rest,
the housing and gears being shaped and dimensioned such that during operation of the differential gear assembly, the gear extending into the reservoir turns and displaces fluid from the reservoir,
the method including the step of
(a) providing a control member shaped and dimensioned such that when the control member is mounted inside the housing adjacent the flange, fluid displaced against the control member is deflected to a selected direction of travel;
(b) installing the control member inside the housing adjacent the flange; and,
(c) operating the differential gear assembly.
